(19) United States
(12) Patent Application Publication
(10) Pub. No.: US 2015/0372576 A1
(43) Pub. Date: Dec. 24, 2015

(54) INDUCTION MOTOR SQUIRREL-CAGE ROTOR BAR RELIEF

(71) Applicant: Ebara International Corporation, Sparks, NV (US)

(72) Inventor: Stephen Hembroff, Sparks, NV (US)

(21) Appl. No.: 14/312,440

(22) Filed: Jun. 23, 2014

(51) Int. Cl. H02K 17/16

(52) U.S. Cl. CPC H02K 17/165

(57) ABSTRACT

A rotor bar relief system and a method of manufacturing a squirrel-cage rotor including a rotor bar relief system are disclosed where a plurality of rotor bars affixed within corresponding slots of an end cap of the shaft of the rotor and where each of the rotor bars has a relief formed in the end of the rotor bar affixed to the slots of the end cap. The reliefs may have a variety of cross sections and the slots may have a variety of shapes. The reliefs can be formed as the rotor bars are extruded or subsequent to production of the rotor bars. The rotor bars may be further inserted along a substantial portion of their lengths into slots in laminations of a core around the shaft. The rotor bars can be used in induction engines or induction generators and are useful in cryogenic systems.

### TECHNICAL FIELD

The field of electrical motors and generators, and in particular, cryogenic compressors, expanders, and pumps.

### BACKGROUND

A squirrel-cage rotor is a common form of rotor (rotating part) of an alternating current (AC) induction motor or induction generator. Induction motors and generators generally include a rotor that rotates through a magnetic field produced by a fixed stator. Squirrel-cage rotors are used in a wide variety of applications, including in motors producing mechanical force from electrical energy and generators producing electric current from mechanical force. The environment for some applications can include very high or low temperatures. For example a compressor or expander for cryogenic liquids must operate far below normal room temperature, and must also sometimes withstand fast changes in temperature. Petroleum refinement and processing plants generally involve compressing gasses into cryogenic liquids and later expanding them back into gasses. Cryogenic liquids are refrigerated liquefied gases with boiling points below −90° C. at atmospheric pressure, though different cryogens become liquids under different conditions of temperature and pressure. Industrial facilities that produce, store, transport and utilize such gases make use of a variety of valves, pumps and expanders to move, control and process the liquids and gases, and these facilities must withstand extreme temperatures and temperature changes.

### SUMMARY

A method of manufacturing a squirrel-cage rotor is disclosed, some general aspects of which include: extruding electrically conductive material to form rotor bars with a uniform cross-section, and forming a thinning relief at an end of the bars and along a short section of the length of the bar adjacent to the ends. The method also includes positioning the bars within slots running through the core of the rotor and within slots in an end ring. The method also includes welding the ends of the bars to an end ring.

An apparatus is also disclosed for a squirrel-cage rotor, some general aspects of which include: electrically conductive rotor bars with ends welded to an end ring, where the bars have a relief along the length of the bar at and near the end of the bar, and where the relief reduces a width of the bar along the length of the bar containing the relief.

### BRIEF DESCRIPTION OF THE DRAWINGS

FIG. 1 illustrates a perspective view of an assembled squirrel-cage rotor in accordance with an embodiment before welding the end ring.

FIG. 2A illustrates a profile view of the end of a rotor bar with relief in accordance with an embodiment.

FIG. 2B illustrates a cross-section view of a rotor bar in accordance with an embodiment.

FIG. 3 illustrates a partially broken, cross-section view of an assembled squirrel-cage rotor in accordance with an embodiment.

FIG. 4A illustrates a top view of an end ring of a squirrel-cage rotor in accordance with an embodiment.

FIG. 4B illustrates a cross-sectional view of an end ring in accordance with an embodiment.

FIG. 5 illustrates a top view of a lamination plate for a squirrel-cage rotor in accordance with an embodiment.

### DETAILED DESCRIPTION OF ILLUSTRATIVE EMBODIMENT

Temperature changes can cause mechanical stress, especially in objects composed of two or more materials that contract and expand at different rates with a temperature change. This is true of any mechanical device undergoing a fast temperature change, and such mechanical stress is exaggerated where the temperature change is exaggerated, as is the case with cryogenic expanders and compressors that involve highly chilled and pressurized gasses. For example, an induction generator may be used in a cryogenic expander to harness the mechanical energy created by a cryogenic liquid as it expands back into a gas. Induction generators can generate AC electricity when the force from an expanding gas turns a rotor, moving the rotor through a magnetic field created, for example, by windings or bars in a fixed stator. A squirrel-cage rotor is type of rotor and is comprised typically of electrically conductive aluminum or copper bars arranged around the circumference of the center shaft of the rotor. These bars are sometimes embedded in the rotor core, held in grooves or slots formed in a stack of thin electrical steel discs called laminations. The laminations are generally centered on and attached to a central rotor shaft. The ends of the rotor bars are connected by a shorting ring or end ring which can be made of aluminum. The aluminum of the end ring and the steel of the laminations shrink at different rates. If the end ring and bars are aluminum and laminations are steel, problems can occur with fast temperature changes. Where an end ring of aluminum physically interfaces or is attached to aluminum bars that run through a steel core of a rotor, stress is created at that end ring/bar interface as the temperature drops, for example as cryogenic fluids are introduced nearby. In designs where the rotor bars are welded to an aluminum end ring, the shear stress at the weld joint can cause a premature failure. This disclosure provides a design that reduces the shear stress at the weld joint and, hence, reduces premature failures. An embodiment of the disclosed design involves a relief (or notch or thinned portion) at the end of the rotor bars that, once welded to an end ring, turns the shear stress at the small weld joint from dropping temperatures into bending stress at a larger weld joint.

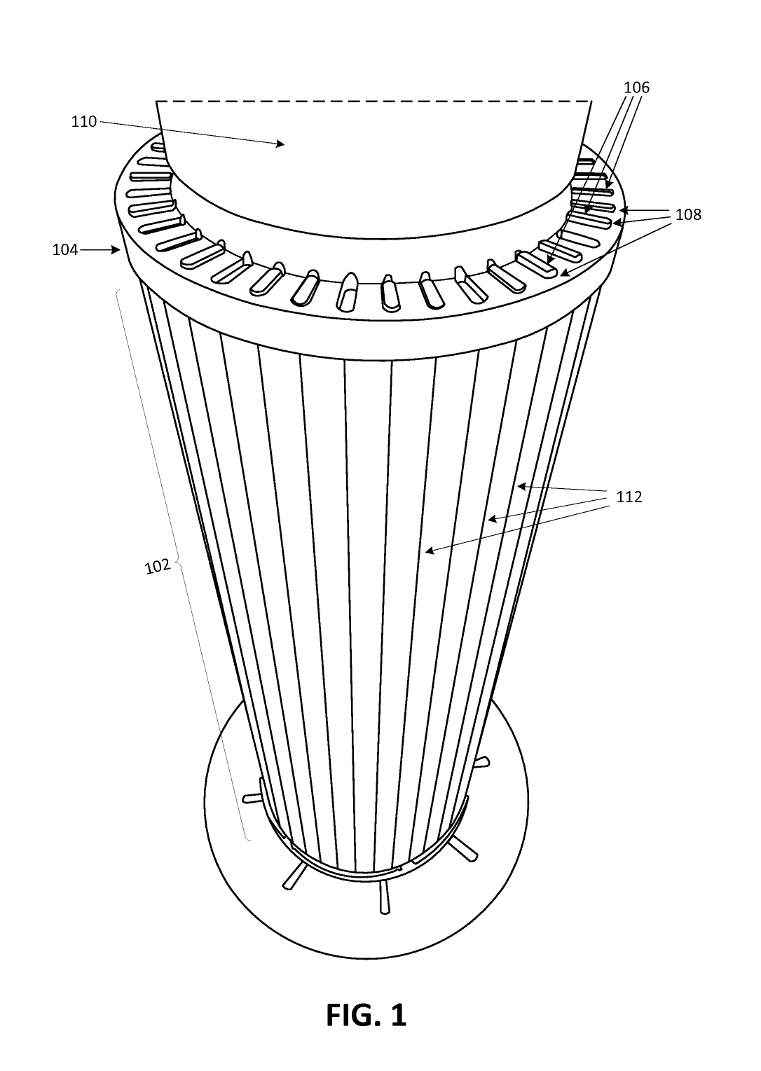

FIG. 1 shows a perspective view of an embodiment of a constructed squirrel-cage rotor prior to welding the rotor bar ends 106 to an end ring 104. A shaft 110 is surrounded by a stack of discs or laminations 102 that form the core of the rotor, each lamination having small gaps 112 around its circumference, with the gaps in the laminations 102 aligned to form the lines labeled 112. Hidden behind each gap is a slot formed by holes in the laminations that are aligned to hold the rotor bars (not otherwise shown in FIG. 1). The ends 106 of the rotor bars protrude somewhat from the laminated core into or through slots in the end ring 104 leaving the bar ends 106 visible in FIG. 1. Weld sites 108 are where the bar ends 106 are welded to the end ring 104, and each weld site 108 includes the area generally around each slot in the end ring and includes the bar end 106 disposed within that slot.

An induction motor or generator works by a magnetic field inducing a current in a conductor that moves through the electric field. The magnetic field is often created by an electromagnet in the stator, or stationary part of the motor, such as copper windings, but can also be produced by fixed or permanent magnets or other types of windings as those skilled in the art will understand. In a motor, the current is induced typically in a rotating rotor which creates a torque causing the rotor to rotate, translating the electrical energy supplied into mechanical torque from the rotor. In a generator, a physical torque is applied to the rotor, pushing the conductors in the rotor through the magnetic field and inducing a current, thereby converting mechanical torque into electrical power. When the rotor of FIG. 1 is surrounded by a magnetic field, the current is induced in the bars that run through the laminations 102 and through the shorting end ring 104. The bars and end ring 104 are shorting in that they have low electrical resistance to allow current to easily flow. The laminations 102 on the other hand, are usually designed to have high magnetic permeability, but are very thin (typically less than 2 millimeters thick) and electrically insulated layers to reduce the size of eddy currents and hence reduce the power lost as heat from caused by the eddy currents in the laminated core. The laminations 102 are usually made of electrical steel, such as silicon steel to increase resistance which both further reduces eddy currents and narrows the hysteresis loop in the laminations 102. Other types of materials can be used for the laminations 102.

A squirrel-cage rotor, such as the one in FIG. 1, can be assembled in many ways. One possibility is to insert a few bars into the slots of a bottom end ring, may be just four spaced at 90 degrees from each other, with the bottom end ring already attached to the center shaft 110. The laminations 102 are then layered on the bottom end ring, carefully inserting the four bars into the correct slots in each lamination 102 as each lamination 102 is lowered onto the shaft 110. The bars may need to be held at specific desired angle, slightly twisted relative to the vertical shaft 110 (perhaps 2 degrees from exactly parallel to the shaft). When all laminations 102 are in place, bars may be inserted into all remaining slots in the laminations 102, and the top end ring 104 is stacked on top of all the laminations. The end bars are then welded to the top end ring. Other orders or processes for assembling these parts are possible.

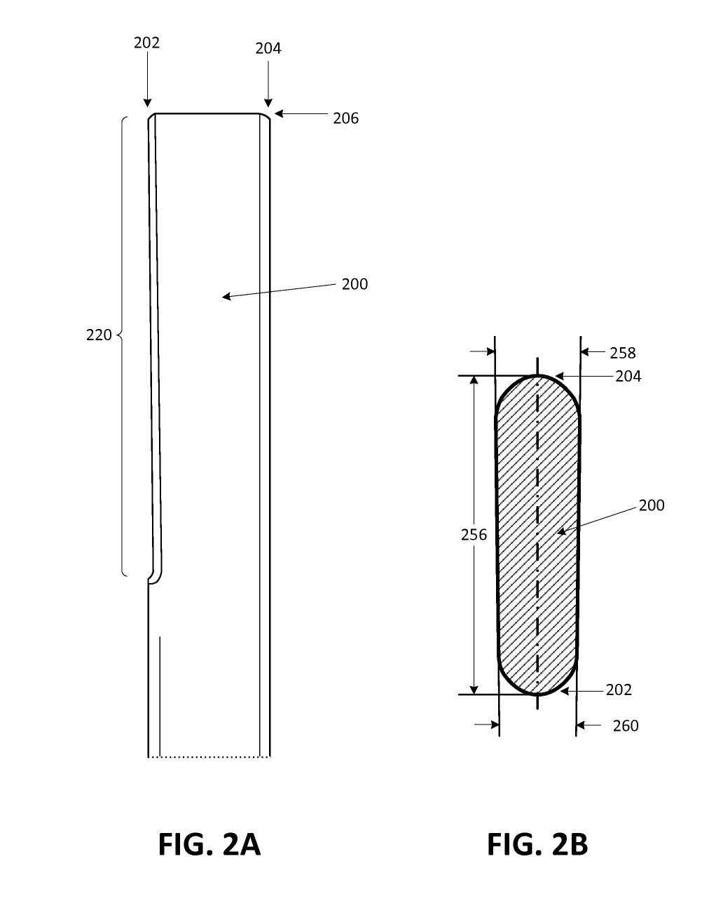

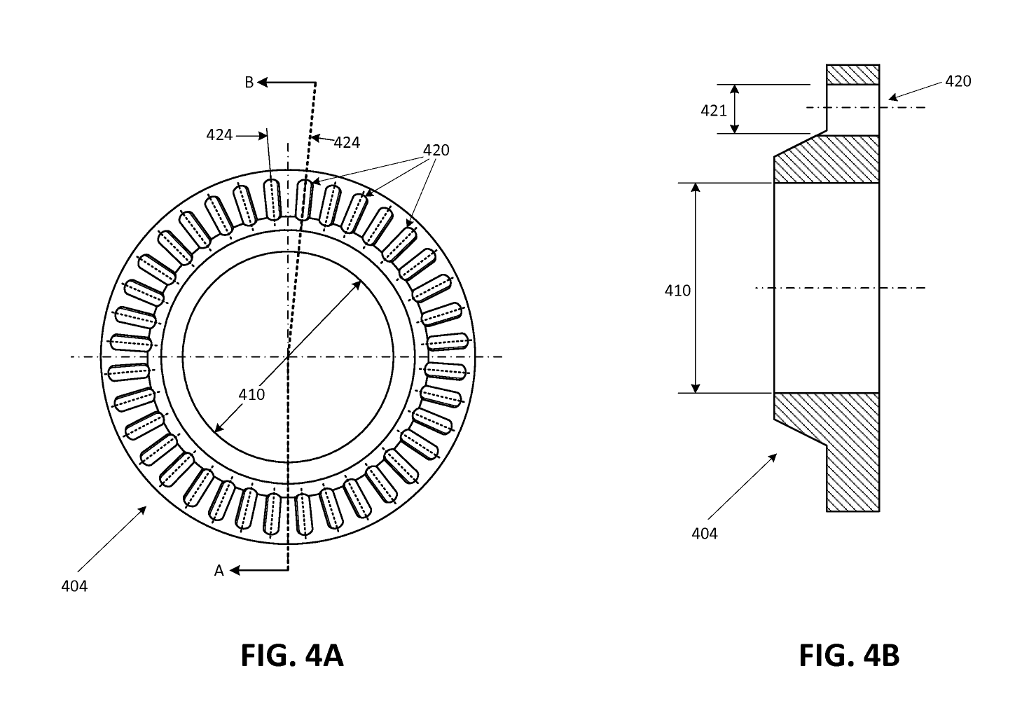

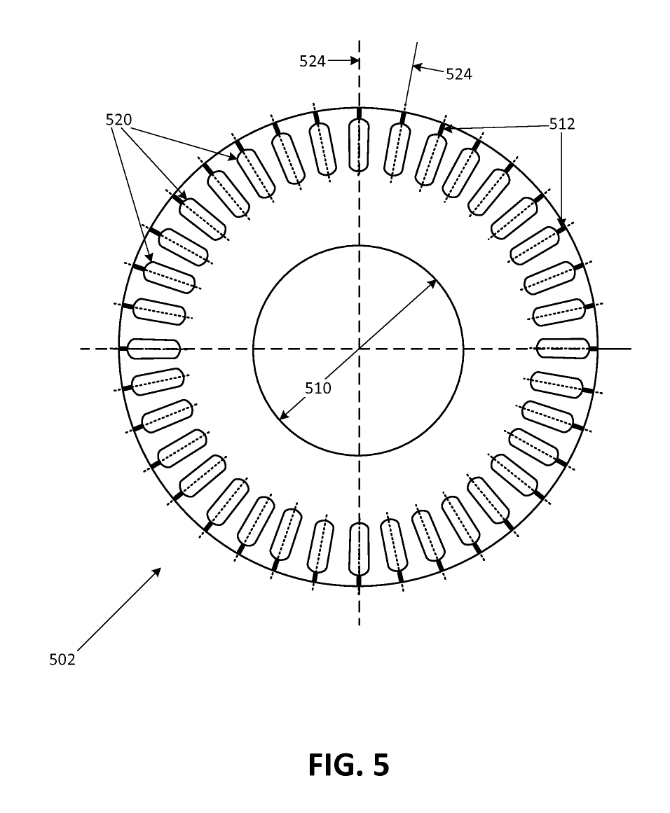

FIGS. 2A and 2B show a profile and cross-sectional view of a rotor bar 200. The bar 200 has an inner edge 202, outer edge 204, and end 206. The end 206 can be inserted in a slot of an end ring, such as slot 420 of end ring 404 in FIG. 4B, and a slot of a lamination, such as slot 520 of lamination in FIG. 5. The inner edge 202 can be positioned closer to the center of a rotor shaft (such as shaft 110 in FIG. 1), while the outer edge 204 may be positioned close to the outer circumference of the laminations and end ring (such as laminations 102 and end ring 104 of FIG. 1). An embodiment disclosed herein includes a relief in either the inner edge 202 or outer edge 204 of a rotor bar 200 at the end 206 of the bar 200. As depicted in FIG. 2A, a relief 220 on the inner edge 202 is a portion of bar 200 where the width from the inner edge 202 to outer edge 204 is smaller than the remaining portion of the bar 200 without the relief 220. In the embodiment of FIG. 2A, the width of bar 200 is constant below the relief 220, and the width with relief 220 is also substantially constant throughout the length of the relief 220, with a smoothed step transition where the relief starts. To reduce the stress at the weld joint for cold cryogenic applications, the relief can be on the inner edge 202, as depicted in FIG. 2A, but for elevated temperatures, the relief can be on the outer edge, such as illustrated by the dashed line 222, which would take the place of relief 220. At cold temperatures, for example, the steel laminations will shrink radially more slowly than the aluminum end ring will shrink radially. In this cold situation, the end ring will pull the bar toward shaft center faster than the slots inside the laminations will allow, creating stress at the weld joint. The relief allows the stress to be distributed along the length of the relief instead of focused in the area right at the weld joint. Other relief designs may be possible, including a relief on both an inner edge and outer edge, or a thinning relief around the entire perimeter of a rotor bar. The length of the relief is short relative to the length of the rotor bar, i.e., a substantial portion (greater than 50%) of the length of the rotor bars may retain the original rotor bar width, while only a smaller portion, perhaps a very small portion, may be thinned by the relief at one or both ends of the rotor bar. Exemplary dimensions of the relief, for a bar width of about 1″, the relief length may be 3″ to 4″, while the thickness of the relief (the amount the bar width is reduced in the area of the relief) may be about 0.04″ to 0.05″. The may be long enough to distribute the bend necessary to compensate for maximum radial shrink or expansion difference between the steel laminations and the aluminum end cap.

FIG. 2B shows the cross-sectional shape of the rotor bar 200, and some dimensions are also indicated. The bar 200 is slightly tapered from outer edge 204 to inner edge 202 such that the thickness of the bar is reduced closer to the center of the rotor shaft. The inner edge 202 and outer edge 204 are rounded by curves that are approximately circular, and the straight sides of bar 200 are tangent to the arcs of the curved inner edge 202 and curved outer edge 204. The edge with a relief, such as inner edge 202 in FIG. 2A, may be shaped substantially identically to the portion of the bar without a relief, or the shape of the portion in relief may be different. Exemplary approximate bar dimensions for a rotor of about 150″ total length might be: a width 256 from inner edge 202 to outer edge 204 of about 1.00″; an inner thickness 260 at inner edge 202 of about 0.25″; and an outer thickness 258 at outer edge 204 of about 0.30″.

One method of manufacturing a bar 200 of FIGS. 2A and 2B is by extruding a bar of uniform cross-sectional shape for the length of the rotor, and then machining a relief 220 into both ends of the bar to reduce the width 256 at the ends by the desired amount. One preferred extrusion material is aluminum alloy 6061-T6 (as specified by the Aluminum Association (AA)), which is precipitation hardened and contains magnesium and silicon as its alloying elements. Other manufacturing methods may be possible, such as forging the rotor bars with a relief directly, and the manufacturing method may depend on the exact type of material used. The bar 200 can be hard (or hardcoated) anodized as per the U.S. Military Specification MIL-A8625, class III, using a sulfuric acid solution for anodizing and leaving an anodized coating thicker than 0.001 inch. Burs and sharp edges can be removed after manufacturing. Other manufacturing methods are possible, as those skilled in the art will understand, and manufacturing methods may depend on the bar shape and the material used.

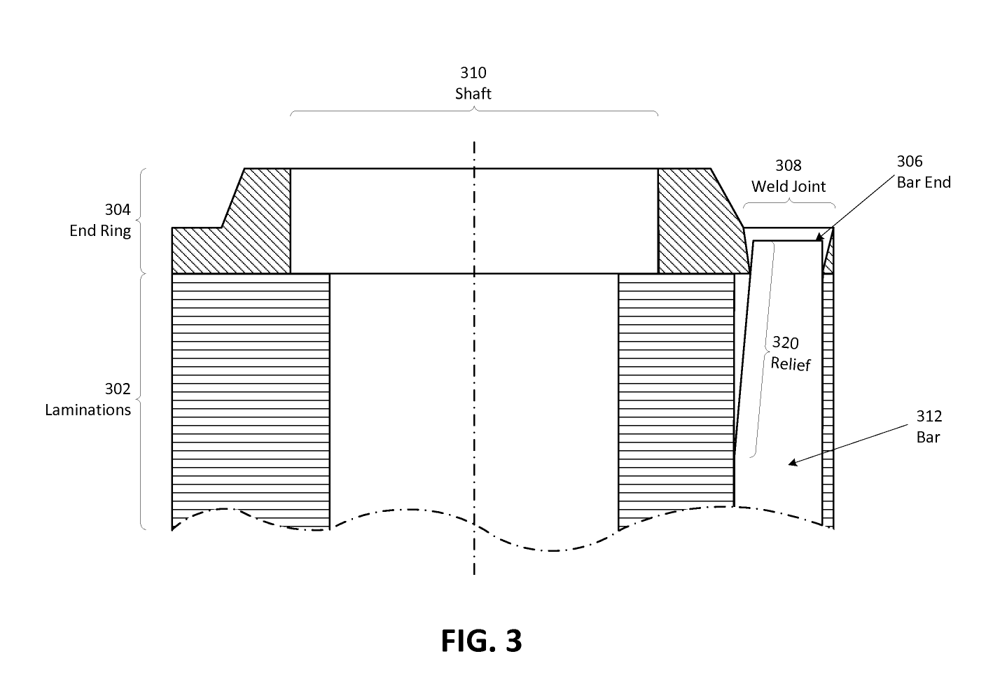

FIG. 3 is a schematic of the end of a rotor constructed around shaft 310. An end ring 304 may sit on top of the laminations 302 and may surround the shaft 310. Slots formed in the laminations 302 and end ring 304 may be aligned to hold bar 312, with bar end 306 perhaps close to the middle of a slot in the end ring 304. The weld joint 308 includes the area just around the slot in the end ring 304 and the bar end 306. The laminations 302 and end ring 304 should include several slots holding bars; FIG. 3 depicts just one bar on the right side of the figure, while the left portion of the figure shows a portion of the end ring 304 and laminations 302 where there is no slot or bar. While the laminations 302 may have an exemplary thickness of only about 0.5 mm, the end ring 304 may have an example thickness of about 5 cm.

In the embodiment of FIG. 3, the relief 320 in the bar 312 is on the interior edge of the bar 312, and is not parallel with the length of the bar 312. As opposed to the constant-width relief 220 in FIG. 2A, the relief 320 is angled such that there is a continuous slope from the bottom of the relief upward toward the bar end 306, and the reduction in width of the bar 312 goes from zero at the start (bottom) of the relief 320 up to a maximum reduction at the bar end 306. Other types of reliefs are possible in addition to what is pictured in FIGS. 2A and 3, such as a stepped relief, or continuously curved relief, and the relief design may take account of magnetic/electrical effects, structural strength of the resulting apparatus, and manufacturing or assembling considerations.

The slot for bar 312 in end ring 304 in the embodiment of FIG. 3 is conical, in that it has sloped edges such that the bar is more tightly held in the slot at the bottom of end ring 304 and more loosely held at the top of the slot. This may allow for a wider weld joint at the very top of bar 312, with the ability for the bar to bend more with reduced sheer stress during temperature changes. The bottom of the slot for bar 312 in end ring 304 may have an exterior wall at an identical distance from the shaft center as the exterior wall of the slot in the laminations 302, leaving a smooth transition in the exterior wall of the slot from laminations 302 to end ring 304. However, the interior of the slot at the bottom of end ring 304 is displaced from the interior of the slot in the laminations to account for the relief 320 on the interior edge of the bar 312, with the result being a step in the interior edge of the slot at the transition from laminations 302 to end ring 304. Note that other designs for the bar slots in an end ring are possible, including a non-conical straight-sided slot, such as slot 420 depicted in FIG. 4B, or a bar slot with curved sides. It may also be noted that the squirrel-cage rotors may generally have rotor bars that are all at an identical slight angles from exactly parallel to rotor shaft. For a squirrel-cage rotor with 40 bars, this angle in all the bars might be around 2 degrees. Such an angle in the bars may be taken into account in the sides of the slots in the end cap, including the sides not depicted in FIGS. 3 and 4B (the sides roughly parallel to the cross-sectional plane used in those figures).

FIGS. 4A and 4B illustrate a top and cross-sectional view of an end ring, such as the end ring 104 in FIG. 1. As shown in FIGS. 4A and 4B, end ring 404 has a large central hole with diameter 410 for receiving the rotor shaft (not shown), and has thirty-six slots 420 around its periphery. The number of slots in a rotor can vary (along with the number of bars in the slots), but the number of slots (and bars) is generally a smaller number than in the stator, and may be a non-integral multiple of stator slots so as to prevent magnetic interlocking of rotor and stator. In the embodiment of FIG. 4A, there are thirty-six slots with about a 10 degree angle 424 between the centers of neighboring slots. Other numbers of bars and slots are possible, including forty bars and slots with about a 9 degree angle between slots, etc.

FIG. 4B is a cross-sectional view through end ring 404 from point A to point B in FIG. 4A. The lower portion of FIG. 4B cuts along the thick dotted line marked from the center to point A in FIG. 4A were there is not a slot, while the upper portion of FIG. 4B cuts along the thick dotted line marked from the center to point B and includes a slot 420. Exemplary dimensions of an end ring for a 150″ rotor might include about a 7.5″ shaft diameter 410, a total diameter of end ring 404 of about 12.25″, and a slot width 421 of about 1.12″.

FIG. 5 is a top view of an embodiment of a lamination 502 for a rotor core, such as the laminations 102 or lamination 302 of FIGS. 1 and 3. As illustrated in FIG. 5, the shaft diameter 510 may about 6″ and be smaller than the shaft diameter 410 in the end ring. In this embodiment, there are thirty-six slots 520 spaced at an angle 524 of about 10 degrees, and there are small gaps 512 connecting the outer circumference of the lamination 502 to the slots 520. The width of the gap around the circumference of the lamination 502 may be about 0.05″. Lamination 502 may be manufactured by stamping silicon steel, have maximum burr size of about 0.003″, and may have coatings such as C5 or C6 (as specified by American Society for Testing and Materials (ASTM) standard A976-03).

In an embodiment of a rotor bar relief system for a squirrel-cage rotor for use within a system containing a stator, the rotor bar relief system comprises an end ring mounted around an end of a shaft of the squirrel-cage rotor; and a plurality of rotor bars, each rotor bar among the plurality of rotor bars including an end affixed to the end ring, each rotor bar being electrically conductive, wherein each rotor bar includes a relief formed along a length of the rotor bar at and near the end of the rotor bar, wherein the relief reduces a width of the rotor bar along the length of the rotor bar containing the relief.

In the embodiment of the rotor bar relief system, wherein the relief is formed on the inner edge of each rotor bar, closest to the center of the shaft. In the embodiment of the rotor bar relief system, wherein the relief is formed on the outer edge of each rotor bar, farthest from the center of the shaft. In the embodiment of the rotor bar relief system, wherein the squirrel-cage rotor is part of an induction motor. In the embodiment of the rotor bar relief system, wherein the squirrel-cage rotor is part of an induction generator. In the embodiment of the rotor bar relief system, wherein the system is an apparatus that processes cryogenic fluids. In the embodiment of the rotor bar relief system, wherein the relief is formed on an edge of each rotor bar, wherein a first shape of the edge in the area of each rotor bar where the relief is formed is substantially similar to a second shape of the edge in an area of each rotor bar where there is no relief formed. In the embodiment of the rotor bar relief system, wherein a portion of each rotor bar that includes the relief has a substantially uniform width and a substantially uniform cross section. In the embodiment of the rotor bar relief system, wherein a portion of each rotor bar with the relief has a width that grows from a minimum at one end of the relief that is at the end of each rotor bar, up to a maximum at a second end of the relief.

In the embodiment of the rotor bar relief system, wherein the end ring includes a plurality of slots formed therein, wherein each slot among the plurality of slots has a width that is constant across a thickness of the end ring; and each end is substantially disposed within one of the slots. In the embodiment of the rotor bar relief system, wherein the end ring includes a plurality of slots formed therein, wherein each slot among the plurality of slots has a width that increases from one end of the slot to another end of the slot; and each end is substantially disposed within one of the slots. In the embodiment of the rotor bar relief system, wherein the end ring includes a plurality of slots formed therein, each slot among the plurality of slots being configured to hold each end of the rotor bars; the squirrel-cage rotor including a core having a plurality of core slots formed therein, each core slot being configured to hold a center length of each rotor bar; and each slot having a width that is smaller than a width of each core slot.

In a method of manufacturing a squirrel-cage rotor, the method comprises forming a plurality of rotor bars, each rotor bar having a substantially uniform cross-section; forming a thinning relief at an end of each rotor bar and along a short section of a length of each rotor bar adjacent to the end; forming a plurality of slots in an end ring configured to be mounted around an end of a shaft of the squirrel-cage rotor; positioning the plurality of rotor bars within the plurality of slots, with one rotor bar perlot; and welding the end of each rotor bar to the end ring.

In the method of manufacturing the squirrel-cage rotor, the method further comprising forming a core around the shaft; and forming a plurality of core slots in the core, each core slot being configured to hold a large section of the length of each rotor bar. In the method of manufacturing the squirrel-cage rotor, the method further comprising forming the core from a stack of laminations. In the method of manufacturing the squirrel-cage rotor, the method further comprising hardcoat-anodizing the rotor bar. In the method of manufacturing the squirrel-cage rotor, the method wherein forming the thinning relief includes machining the rotor bar. In the method of manufacturing the squirrel-cage rotor, the method wherein forming the thinning relief includes forming the thinning relief along an inner edge of the rotor bar closest to the shaft. In the method of manufacturing the squirrel-cage rotor, the method wherein forming the thinning relief includes forming the thinning relief along an outer edge of the rotor bar farthest from to the shaft. In the method of manufacturing the squirrel-cage rotor, the method wherein forming the thinning relief includes reducing a circumference of the rotor bar long the short section such that the a cross-sectional shape of the rotor bar within the short section is substantially similar to a cross-sectional shape of rotor bar outside of the short section.

While this document contains many specifics, these should not be construed as limitations on the scope of an invention or of what may be claimed, but rather as descriptions of features specific to particular embodiments of the invention. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be exercised from the combination, and the claimed combination may be directed to a subcombination or a variation of a subcombination.

What is claimed:

1. A rotor bar relief system for a squirrel-cage rotor for use within a system containing a stator, comprising:
an end ring mounted around an end of a shaft of the squirrel-cage rotor; and
a plurality of rotor bars, each rotor bar among the plurality of rotor bars including an end affixed to the end ring, each rotor bar being electrically conductive, wherein each rotor bar includes a relief formed along a length of the rotor bar at and near the end of the rotor bar, wherein the relief reduces a width of the rotor bar along the length of the rotor bar containing the relief.

2. The rotor bar relief system of claim 1, wherein the relief is formed on the inner edge of each rotor bar, closest to the center of the shaft.

3. The rotor bar relief system of claim 1, wherein the relief is formed on the outer edge of each rotor bar, farthest from the center of the shaft.

4. The rotor bar relief system of claim 1, wherein the squirrel-cage rotor is part of an induction motor.

5. The rotor bar relief system of claim 1, wherein the squirrel-cage rotor is part of an induction generator.

6. The rotor bar relief system of claim 1, wherein the system is an apparatus that processes cryogenic fluids.

7. The rotor bar relief system of claim 1, wherein the relief is formed on an edge of each rotor bar, wherein a first shape of the edge in the area of each rotor bar where the relief is formed is substantially similar to a second shape of the edge in an area of each rotor bar where there is no relief formed.

8. The rotor bar relief system of claim 1, wherein a portion of each rotor bar that includes the relief has a substantially uniform width and a substantially uniform cross section.

9. The rotor bar relief system of claim 1, wherein a portion of each rotor bar with the relief has a width that grows from a minimum at one end of the relief that is at the end of each rotor bar, up to a maximum at a second end of the relief.

10. The rotor bar relief system of claim 1, wherein:
the end ring includes a plurality of slots formed therein, wherein each slot among the plurality of slots has a width that is constant across a thickness of the end ring; and
each end is substantially disposed within one of the slots.

11. The rotor bar relief system of claim 1, wherein:
the end ring includes a plurality of slots formed therein, wherein each slot among the plurality of slots has a width that increases from one end of the slot to another end of the slot; and
each end is substantially disposed within one of the slots.

12. The rotor bar relief system of claim 1, wherein:
the end ring includes a plurality of slots formed therein, each slot among the plurality of slots being configured to hold each end of the rotor bars;
the squirrel-cage rotor including a core having a plurality of core slots formed therein, each core slot being configured to hold a center length of each rotor bar; and
each slot having a width that is smaller than a width of each core slot.

13. A method of manufacturing a squirrel-cage rotor, comprising:
forming a plurality of rotor bars, each rotor bar having a substantially uniform cross-section;
forming a thinning relief at an end of each rotor bar and along a short section of a length of each rotor bar adjacent to the end;
forming a plurality of slots in an end ring configured to be mounted around an end of a shaft of the squirrel-cage rotor;
positioning the plurality of rotor bars within the plurality of slots, with one rotor bar perlot; and
welding the end of each rotor bar to the end ring.

14. The method of claim 13, further comprising:
forming a core around the shaft; and
forming a plurality of core slots in the core, each core slot being configured to hold a large section of the length of each rotor bar.

15. The method of claim 14, further comprising forming the core from a stack of laminations.

16. The method of claim 13, further comprising hardcoat-anodizing the rotor bar.

17. The method of claim 13, wherein forming the thinning relief includes machining the rotor bar.

18. The method of claim 13, wherein forming the thinning relief includes forming the thinning relief along an inner edge of the rotor bar closest to the shaft.

19. The method of claim 13, wherein forming the thinning relief includes forming the thinning relief along an outer edge of the rotor bar farthest from to the shaft.

20. The method of claim 13, wherein forming the thinning relief includes reducing a circumference of the rotor bar long the short section such that a cross-sectional shape of the rotor bar within the short section is substantially similar to a cross-sectional shape of rotor bar outside of the short section.
